(19) United States
(12) Patent Application Publication
(10) Pub. No.: US 2012/0191835 A1
(43) Pub. Date: Jul. 26, 2012

(54) Locating and Retrieving Packages Over a Network

(75) Inventors: Mark Blackburn, Maidenhead (GB); Sophie Chang, Ealing (GB)

(73) Assignee: 1E LIMITED, London (GB)

(21) Appl. No.: 13/356,448

(22) Filed: Jan. 23, 2012

(30) Foreign Application Priority Data
Jan. 21, 2011 (GB) 1101095.6

(51) Int. Cl. G06F 15/16

(52) U.S. Cl. 709/223

(57) ABSTRACT

A computer-implemented method of locating and retrieving a package over a network, including a management server, is provided. The method includes sending a package request, determining a subset of primary nodes, receiving a response including address data associated with the determined subset of primary nodes, determining one or more metrics associated with each of the subset of primary nodes to determine a useful primary node, sending a request for the package, upon receipt of the request determining one or more neighbour nodes on the second subnet holding part or all of the requested package, receiving a response including address data associated with the determined one or more neighbour nodes, selecting one or more target nodes from the one or more neighbour nodes, and retrieving part or all of the package from the selected one or more target nodes.

### CROSS-REFERENCE TO RELATED APPLICATIONS

This application claims priority to foreign Patent Application GB 1101095.6, filed on Jan. 21, 2011, the disclosure of which is incorporated herein by reference in its entirety.

### FIELD OF THE INVENTION

The present invention relates to locating and retrieving packages over a network, and in particular but not exclusively to locating and retrieving packages from remote subnets.

### BACKGROUND OF THE INVENTION

Large organizations often have several geographically separate branch sites, each of which will typically comprise a plurality of machines or nodes interconnected via a Local Area Network (LAN) comprising one or more logically distinct subnets. The nodes and their corresponding subnets are coordinated across a larger network such as a Wide Area Network (WAN) which provides connectivity between the various subnets, and thus connectivity between branch sites.

In order to ensure that the software configuration of a node in the network is maintained in an up-to-date state, the node may be required or otherwise instructed to locate and retrieve data packages from the network. For example, upon receiving notification that an operating system patch has been released, a node may attempt to locate and retrieve the corresponding package from the network. Packages retrieved in this manner may comprise any type of data or software, including but not limited to software applications, software updates or patches, operating system components, virus definition files, and security policy configuration files. Where the network includes hundreds, thousands, or even tens of thousands of nodes distributed across multiple subnets, it will be appreciated that efficiently locating and retrieving the specified package poses considerable technical challenges.

In simple network infrastructures, it is generally acceptable for nodes to retrieve packages from a single distribution point on the WAN (e.g. a dedicated distribution server). However, this approach suffers from several drawbacks, particularly where the distribution point is located on a remote section or subnet of the WAN and the package data must be transferred over a non-optimal link such as DSL, ISDN or satellite. Typically, the bandwidth of a link of this type is limited and consequently day-to-day network traffic is often adversely affected by the transfer of packages. Where several nodes attempt to retrieve the package simultaneously, network performance will be severely affected. Moreover, where there is only a single distribution point in the WAN, the load on the network and the distribution point scales roughly in proportion to the number of nodes in the network. Of course, this drawback can be obviated by introducing additional distribution points to the WAN but such an approach typically leads to increased equipment cost and administrative overhead.

In an alternative approach, each subnet is associated with a local package server which retrieves the specified package from the WAN and makes it available to nodes on the local subnet. Whilst negating the need to retrieve multiple copies of the specified package over the WAN to the local subnet, this solution requires a dedicated server for each subnet, thus incurring additional equipment cost and administrative overhead. Furthermore, if the local package server becomes unavailable (e.g. due to hardware failure or power loss) then none of the nodes on the local subnet are able to retrieve packages.

One solution to the problems described above is provided by Nomad Branch® of 1E Limited, which is the subject of U.S. Pat. No. 7,362,758, hereby incorporated in its entirety by reference. Nomad Branch® works by electing a node on the local subnet to retrieve a particular package from a distribution point located on the WAN or even external to the WAN. Once the elected node has retrieved the package, it is shared with all other nodes requiring the package on the local subnet (e.g. using a broadcast or multicast operation). The Nomad Branch® mechanism generally works well for distributing systems management workloads in distributed branch office environments as only one node per subnet is required to download the specified package. Thus, package data only travels over the WAN once to a given subnet and there is no requirement for a subnet to have a local package server to support package distributions to nodes on the local subnet. Furthermore, in the Nomad Branch® approach no single node is relied upon to download the package and if the elected node fails or is powered down, another node on the LAN may be elected to take its place. Nomad Branch® can also be used to distribute large packages to many nodes simultaneously using multicast functionality. This feature is not bound to a local subnet; however, enabling multicast functionality over a large network infrastructure is often unattractive due to the large administrative overhead.

### SUMMARY OF THE INVENTION

In accordance with a first aspect of the present invention, there is provided a computer-implemented method of locating and retrieving a package over a network. The network comprises a management server storing data relating to a plurality of primary nodes and each primary node is associated with a subnet of the network and responsible for locating the package on its associated network. The method comprises: sending, from a requesting node on a first subnet, a package request to the management server, wherein upon receipt of the package request the management server determines a subset of the primary nodes; receiving at the requesting node a response from the management server comprising address data associated with the determined subset of primary nodes; determining at the requesting node one or more metrics associated with each of the subset of primary nodes so as to determine a useful primary node on a second subnet; sending from the requesting node on the first subnet a request for the package to the determined useful primary node on the second subnet, wherein upon receipt of the request the said useful primary node determines one or more neighbour nodes on the second subnet holding part or all of the requested package; receiving at the requesting node on the first subnet a response from the determined useful primary node comprising address data associated with the determined one or more neighbour nodes holding part or all of the requested package; and, selecting at the requesting node one or more target nodes from the one or more neighbour nodes and retrieving to the requesting node part or all of the package from the selected one or more target nodes.

In accordance with a second aspect of the present invention, there is provided a management server for use in a computer-implemented method of locating and retrieving a package over a network. The network comprises a plurality of primary nodes and each primary node is associated with a subnet of the network and responsible for locating the package on its associated network. The management server stores data relating to the plurality of primary nodes; the management server is responsive to a package request from a requesting node on a first subnet, to the management server, and upon receipt of the package request the management server determines a subset of the primary nodes and sends to the requesting node a response comprising address data associated with the determined subset of primary nodes.

In accordance with a third aspect of the present invention, there is provided a node for use in a network having a management server and a plurality of primary nodes. Each primary node is associated with a subnet of the network and responsible for locating the package on its associated network, the management server stores data relating to the plurality of primary nodes. The node is operable to send a package request to the management server, and is responsive to receipt of data from the management server of data relating to a subset of the primary nodes to determine one or more metrics associated with each of the subset of primary nodes so as to determine a useful primary node on a second subnet. The node is operable to send a request for the package to the determined useful primary node on the second subnet, wherein upon receipt of the request the said useful primary node determines one or more neighbour nodes on the respective subnet holding part or all of the requested package. The node is operable to receive a response from the determined useful primary node, the response comprising address data associated with the determined one or more neighbour nodes holding part or all of the requested package; and, the node being operable to select one or more target nodes from the one or more neighbour nodes and retrieve part or all of the package from the selected one or more target nodes.

In accordance with a fourth aspect of the present invention, there is provided a computer program product comprising a non-transitory computer-readable storage medium having computer readable instructions stored thereon, the computer readable instructions being executable by a computerized device to cause the computerized device to perform a method for locating and retrieving a package over a network. The network comprises a management server storing data relating to a plurality of primary nodes and each primary node is associated with a subnet of the network and responsible for locating the package on its associated network. The method comprises: sending, from a requesting node on a first subnet, a package request to the management server, wherein upon receipt of the package request the management server determines a subset of the primary nodes; receiving at the requesting node a response from the management server comprising address data associated with the determined subset of primary nodes; determining at the requesting node one or more metrics associated with each of the subset of primary nodes so as to determine a useful primary node on a second subnet; sending from the requesting node on the first subnet a request for the package to the determined useful primary node on the second subnet, wherein upon receipt of the request the said useful primary node determines one or more neighbour nodes on the second subnet holding part or all of the requested package; receiving at the requesting node on the first subnet a response from the determined useful primary node comprising address data associated with the determined one or more neighbour nodes holding part or all of the requested package; and, selecting at the requesting node one or more target nodes from the one or more neighbour nodes and retrieving to the requesting node part or all of the package from the determined one or more target nodes.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic block diagram of a wide area network in accordance with an embodiment of the present invention.

FIG. 2 is a timing chart showing a method accordance with an embodiment of the present invention.

FIG. 3 is a schematic block diagram of a node in accordance with an embodiment of the present invention.

FIG. 4 is a schematic block diagram of a management server in accordance with an embodiment of the present invention.

### DETAILED DESCRIPTION

In many WAN infrastructures (e.g. where there are many wireless hubs or a complex network infrastructure), the best node from which to retrieve packages may not necessarily be on the local subnet: a node located on a different subnet may provide a better option for downloading the specified package.

Embodiments of the present invention provide a means for a node on a local subnet of a WAN to efficiently locate and retrieve a package from a different subnet. More specifically, embodiments of the invention provide a means whereby a local node can determine one or more suitable neighbour nodes on different subnets which hold a part or whole of the package.

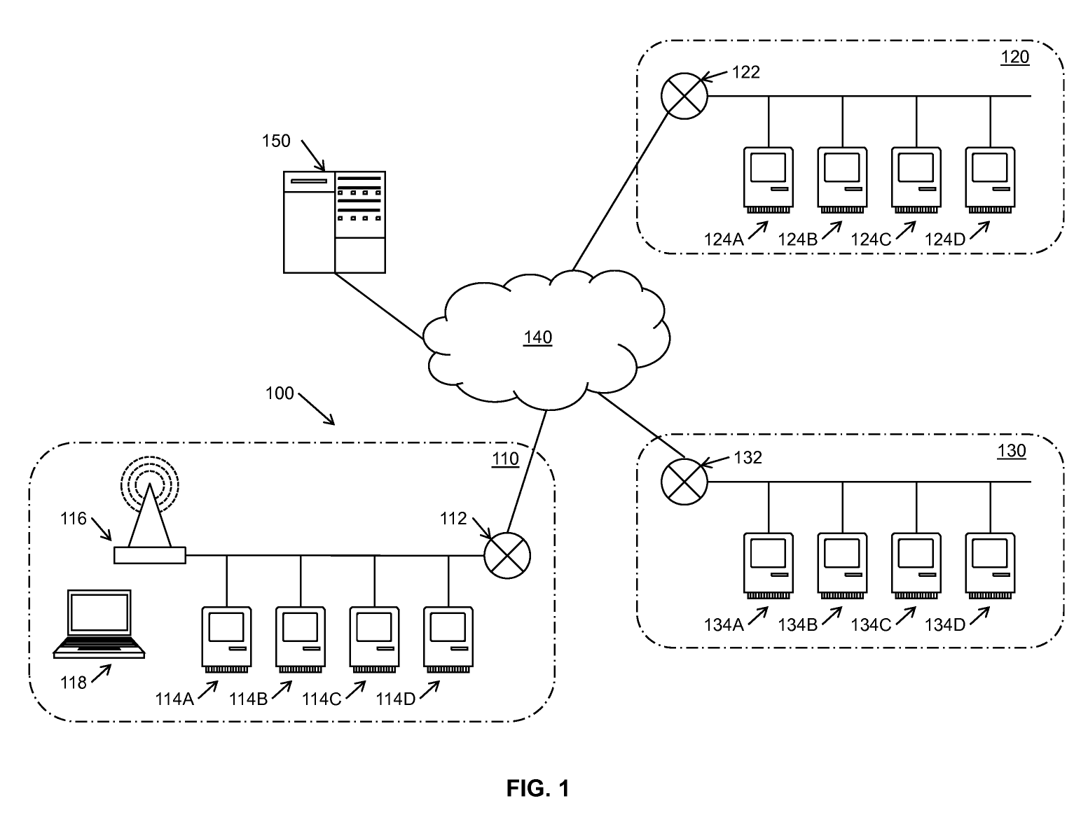

FIG. 1 shows a WAN 100 in accordance with an embodiment of the present invention. The WAN 100 comprises a plurality of subnets 110, 120, 130 corresponding to geographically remote or separate branches of an organisation. Each subnet 110, 120, 130 typically includes a plurality of nodes 114A-D, 124A-D, 134A-D which are connected by and communicate over a LAN such as Ethernet. The nodes may comprise one or more servers, workstations, laptops, personal digital assistants (PDA), smart phones or any other network enabled device. Moreover, the subnet may comprise one or more wireless portions (e.g. subnet 110 includes laptop 118 which can access the subnet 110 via wireless access point 116). Typically, the communications between the subnets 110,120,130 are facilitated using a Virtual Private Network (VPN) layered over the Internet 140 to create the WAN 100. However, in alternative embodiments the subnets 110, 120, 130 may be interconnected using alternative technologies including point-to-point (e.g. a leased line), circuit switching, and packet-switched technologies, such that a routable path exists between node pairs on different subnets.

In the embodiment shown in FIG. 1, each of the subnets 110, 120, 130 includes a router 112, 122, 132 that routes network communications between nodes on a particular subnet and remote subnets in the WAN 100 as a whole. Thus, communications from a node on a local subnet to a node on a remote subnet are routed by at least a local router associated with the local subnet and a router associated with the remote subnet. In other words, the router acts as a gateway that serves as an access point to and from the associated subnet. For example, communications between node 114A (on subnet 110) and node 124D (on subnet 120) are routed via routers 112, 122 and the Internet 140.

Each node in the WAN 100 is assigned an IP address, which is unique within the logical scope of the WAN 100. Typically, where the WAN 100 is implemented using a VPN protocol, each of the nodes will be assigned a private IP address which permits routing within the logical scope of WAN 100 but which is not routable from the public Internet (e.g. IPv4 class C reserved space 192.168.0.0/16). In some embodiments, the nodes may be additionally assigned a hostname unique within the scope of WAN 100 using a protocol such as Domain Name Server (DNS), thereby providing means to resolve each hostname to a respective IP address. Mapping between hostname and IP address may be configured statically or dynamically using a protocol such as Dynamic Host Configuration Protocol (DCHP). Thus, in the present embodiment, a node in WAN 100 can send data to any node in WAN 100 if it has knowledge of the destination node's IP address and/or hostname.

Nodes 114A-D, 124A-D and 134A-D run a software management agent which provides the necessary functionality to locate and retrieve packages over WAN 100. Nodes running the management agent can assume or be assigned a primary role for the respective subnet (hereinafter termed ‘primary nodes’). Preferably, at least one of the nodes on each of the subnets 110, 120, 130 functions as a primary node for the respective subnet. Where possible primary nodes are typically servers, workstations, laptops or hardware appliances on the respective subnet that are powered on and available to perform management tasks for that subnet.

Generally, each primary node is elected from amongst the available nodes located on the respective subnet or are selected by the management server 150. In some embodiments, primary nodes may be further elected or selected on a package basis. Thus, a subnet may include several primary nodes associated with different respective packages. Further details of the selection and election of primary nodes are provided below.

All nodes running the management agent are configured to report an inventory to a management server 150. Typically, the inventory includes sufficient information to enable communications to be addressed to the corresponding node from any other node on WAN 100. This information will include the node's IP address and/or hostname, thereby providing means for a node on a different subnet to communicate with the node in question. In a preferred embodiment the inventory will also include details of the node's role (e.g. is the node a primary node?), hardware configuration, network connection, network location and other pertinent information such as physical location. In further embodiments, the hardware information preferably comprises relatively basic information such as an indication as to whether the node is a server, a workstation or a laptop.

The nodes send their respective inventory information to the management server 150 periodically, or when information in the inventory is changed. In the latter case, the inventory may be resent if the IP address and/or hostname of the node changes. In addition, a new node running the management agent will generally send its inventory to the management server 150 by default upon initiation.

The management server 150 is located such that all nodes 114A-D, 124A-D, 134A-D are able to contact the node and provide inventory data. For a typical organisation, the management server is located in a central data centre but may alternatively be implemented as a virtual server in a cloud-computing infrastructure. Thus, by necessity all nodes running the management agent hold data specifying the network location of the management server 150. In FIG. 1 the management server 150 is connected directly to the Internet via a publicly routable IP address and is external to the WAN 100; however, it will be appreciated that the management server 150 may also be located on WAN 100 and accessed via any one of the subnets 110, 120, 130.

The management server 150 runs a software server agent, which provides the necessary functionality to facilitate retrieval of packages over the WAN 100. The management server 150, running the server agent, stores the inventory data for each node and uses this data to generate a network map that, in its simplest, form is a list of nodes running the management agent and their respective IP addresses or hostnames. More complex network maps may be stored in database (e.g. an SQL database) and include data associating paths between the nodes and subnets 110, 120, 130 in the WAN 100 with one or more metrics, details of which are provided below.

A particular node in the WAN 100 can be instructed to locate and retrieve a package (hereinafter termed a ‘target package’) by command line, by checking an update server, or by instruction from a remote systems management server (e.g. running Microsoft® System Centre Configuration Manager). Typically, the target package will be identified by a package ID, a package version number, and a hash value. Given that retrieving the target package from the local subnet will normally be the best mechanism for retrieval, the requesting node performs an initial election process to determine if any of the other nodes on the local subnet possess or are currently downloading the target package. Accordingly, if a node on the local subnet has the target package, it will respond by providing the package to the requesting node. Local subnet election and retrieval in this manner may be achieved using existing functionality such as the Nomad Branch® functionality described above.

If none of the nodes on the local subnet respond (i.e. none of the local subnet nodes are in possession of, or are in the process of downloading the target package), the requesting node contacts the management server 150 to request a list of primary nodes on other subnets in the WAN 100. The management server 150 selects or determines a subset of the primary nodes (hereinafter termed ‘candidate nodes’) suitable for the requesting node and associated local subnet. Selection of candidate nodes may be performed based on various metrics, details of which are provided below. However, generally speaking, the selected candidate nodes are those primary nodes determined to be switched on (i.e. powered) and in close network proximity to the requesting node.

Once the candidate nodes have been selected, the management server 150 returns a list including the address data for each candidate node (e.g. IP address, and/or hostname retrieved from the network map). Where some candidate nodes have been determined as ‘better’ candidates than others, the list may be appropriately ordered or include ranking data. Alternatively, the list may be randomised to ensure load balancing between the candidate nodes.

Upon receipt of the list of candidate nodes, the requesting node runs a number of tests to determine one or more metrics associated with each candidate node included in the list. For example, these tests may include:
Determining if a route to a candidate node exists (i.e. is the candidate node switched on and contactable?).
Determining the hop-count from the requesting node to a candidate node (i.e. the network proximity of the candidate node).
Determining the bandwidth associated with a candidate node.

The above list of metrics is not exhaustive and it will be appreciated that many alternative metrics associated with the route or path to a candidate node may be determined by the requesting node. Additional metrics include: path utilisation, path speed, path packet loss, path reliability, path bandwidth, path throughput, and path MTU (maximum transmission unit). Generally speaking, low metric values are preferable for path utilisation and path packet loss and high metric values are preferable for path speed, path reliability, path bandwidth, and path throughput. In some embodiments, the determined metrics are sent by the requesting node to the management server 150 where they are used by the management server 150 to improve the centrally stored network map so that future lists are more likely to contain useful candidate nodes.

Once the tests have been completed, the requesting node may disregard one or more of the candidate nodes based on the determined metrics (e.g. candidate nodes that cannot be contacted or have bandwidth below a prescribed cut-off). Alternatively or additionally, the requesting node may rank the candidate nodes according to the determined metrics and contact the highest-ranking candidate nodes(s) first.

Once the requesting node has determined a useful subset of the candidate nodes to contact (hereinafter termed ‘useful candidate nodes’), the requesting node sends a package request to the each of the useful candidate nodes in turn, requesting that they locate the target package on their respective remote subnets. Typically, the request will include information sufficient to identify the target package (e.g. package ID, package version). Upon receipt of the package request, each useful candidate node performs a local subnet broadcast or multicast to determine which nodes on the corresponding remote subnet hold the target package or part of the target package or are currently downloading the package (e.g. using the Nomad Branch® FindPackageStatus request). Nodes holding the package respond to the useful candidate node, indicating the target package version and percentage of the package held.

Once a useful candidate node has determined those nodes on the associated subnet holding part or the whole of the target package (hereinafter termed ‘neighbour nodes’), it returns this information to the requesting node in the form of a list. The list will typically include the IP address and/or hostname for each neighbour node and the version and percentage of the target package held by the neighbour node. In some embodiments, the candidate node may filter the list; for example, to restrict the list to only those neighbour nodes holding the most current version of the target package, or only those neighbour nodes holding one hundred percent of any version of the target package.

Once the requesting node has obtained the list of neighbour nodes for the target package from all useful candidate node(s), the requesting node selects a neighbour node from which to retrieve the target package (herein after termed the ‘target node’). In some embodiments, neighbour nodes that are in possession of 100% of the current version of the package are configured to respond more quickly than nodes with less than 100% of the package, thereby ensuring that they are selected first. Neighbour nodes than have previous versions of the package or less than 100% of the package will be evaluated to determine the most appropriate target node. Typically, the target node will be the neighbour node holding the highest percentage of the most up-to-date version of the target package with acceptable network performance. Additionally, metrics associated with the candidate nodes for the same subnet, such as bandwidth and hop count, may also be referenced when selecting the target node. Once the target node has been selected, the requesting node connects directly to the target node (using the supplied IP address and/or hostname) and copies the target package across the WAN 100.

In some embodiments, the requesting node may download the target package from a plurality of target nodes; for example, where it is determined that no single neighbour node holds one hundred percent of the target package. Retrieval of partial packages from multiple neighbour nodes can be coordinated using methods as are known in the art (e.g. the methods disclosed in U.S. Pat. No. 7,362,758).

If the requesting node is unable to retrieve the target package from the neighbour nodes or the retrieved package is found to be corrupted, the requesting node will query the management server 150 for another list of candidate nodes and the process of finding a target node is repeated.

Typically, each package comprises one or more files and a manifest comprising a hash value for each of the files (e.g. a cyclic redundancy check (CRC) or a polynomial checksum). The remote systems management server instructing the requesting node provides the package hash for verification purposes in addition to the package name and version number. Where several versions of the package exist, the remote systems management server may provide a hash for each version. After the target package has been retrieved, it can be verified as a whole (using the hash value initially provided) and the individual files in the package are verified (using the hash value contained in the package manifest). Once the package has been verified, and providing certain network metrics associated with the connection between the local node and the remote nodes were within predefined limits (e.g. path hop count, path bandwidth), the requesting node will report back to the management server 150 to vote that the corresponding candidate node (and associated subnet) is ‘good’. When subsequently determining a list of candidate nodes, the management server 150 may account for the votes associated with previous package requests (discussed in more detail below). If the requesting node is unable to contact the candidate nodes or no remote nodes were found to have the target package (e.g. it may never have been distributed), the requesting node will eventually exhaust the list of candidate nodes provided by the management server 150. At this point the management server 150 will return the original package source location and the requesting node will retrieve the package directly, thus making it available to all nodes on the WAN 100 for subsequent package requests.

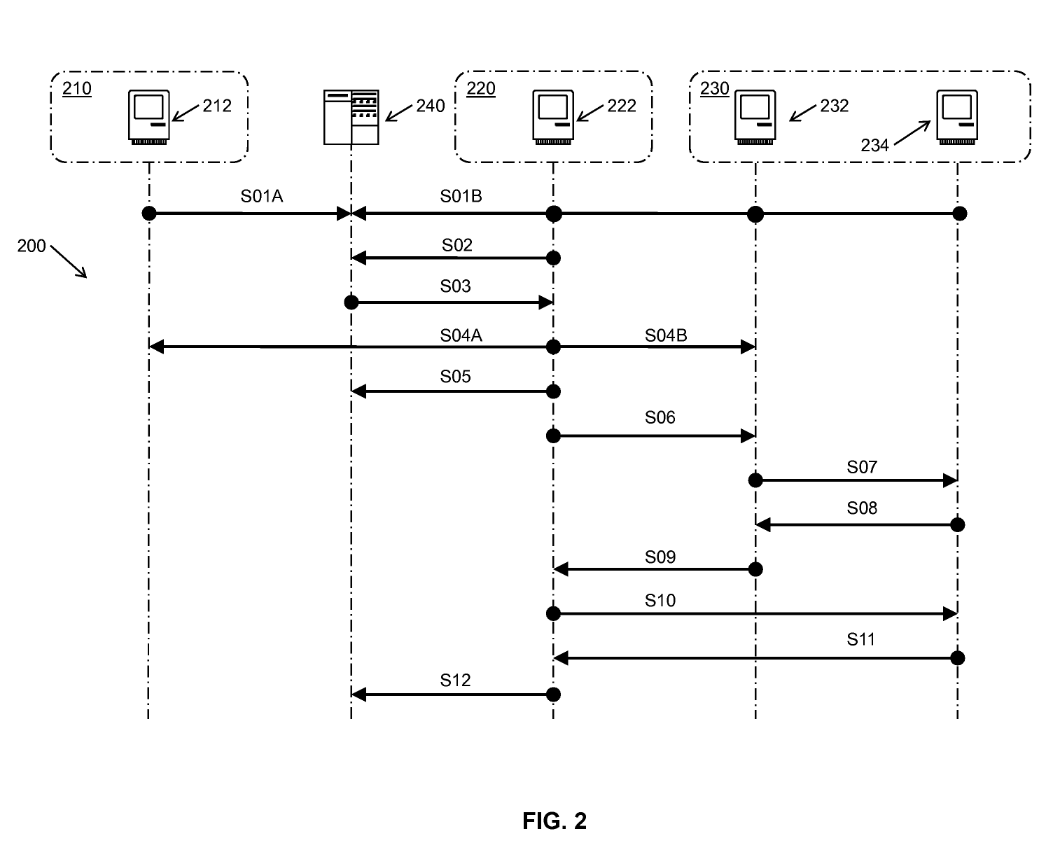

FIG. 2 shows the steps involved in a method 200 for locating and retrieving a target package in accordance with an embodiment of the present invention. Shown in FIG. 2 are a first, second and third subnets denoted 210, 220 and 230 respectively, and a management server 240. Subnet 210 comprises a node 212, which is the elected primary node for the respective subnet 210. Subnet 230 comprises nodes 232, 234, of which node 232 is the elected primary node for the respective subnet 230. Finally, subnet 220 is shown to include node 222. It will be appreciated that each of the subnets may comprise multiple nodes, but for the sake of clarity, only those nodes of relevance to the following description have been included in FIG. 2. Each of the subnets 210, 220, 230 and the management server 240 are connected over a WAN and typically communicate via a VPN through the Internet (not shown).

Firstly, all nodes 212, 222, 232, 234 send their inventories to management server 240 [steps S01A and S01B (note that the inventories may be sent at different times)] and the management server 240 stores the inventories. In the illustrated embodiment, the requesting node 222 has been instructed to download the target package and sends a package request to the management server 240 [step S02]. Upon receipt of the request, the management server 240 determines a list of candidate nodes and returns the list to the requesting node 222 [step S03]. The list includes IP or hostname address details for candidate nodes 212 and 232 on subnets 210 and 230 respectively. Next, the requesting node 222 runs a number of tests to determine metrics associated with each candidate node [steps S04A, S04B] and communicates the results of the test to the management server 240 [step S05]. In the illustrated embodiment, the requesting node 222 determines that the candidate node 232 is a useful candidate node and sends a package request [step S06]. Candidate node 232 on receipt of the request then contacts other nodes 234 on subnet 230 to determine if they are holding the requested package (in part or whole, or a previous version) [step S07]. In the illustrated embodiment, node 234 responds with a message indicating that it holds the requested package [step S08] and the candidate node 232 notifies the requesting node 222 of the network address (e.g. IP address, hostname) of node 234 [step S09]. Finally, the requesting node 222 requests the target package from node 234 [step S10] and retrieves the target package [step S11]. Optionally, the requesting node 222 may send a message to the management server indicating a positive vote for candidate node 232.

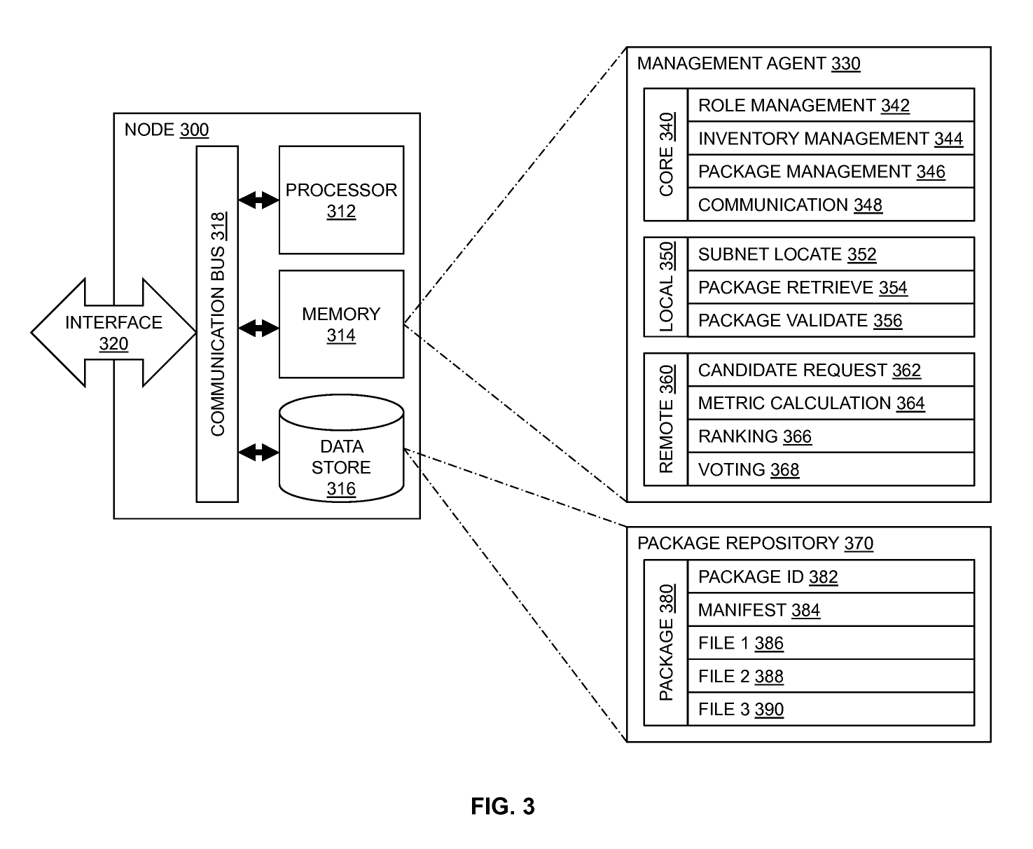

An embodiment of a node running the management agent is now described with reference to FIG. 3. As discussed above, the management agent provides the necessary functionality to locate and retrieve packages on the WAN. In an embodiment of the invention, functionality provided by the management agent may be grouped according to (i) core functionality, (ii) local functionality, and (iii) remote functionality. This functionality is provided by respective core, local and remote modules, which are described in more detail below.

FIG. 3 shows a node 300 in accordance with an embodiment of the invention. As mentioned above, the node is typically a server, workstation or a laptop, but may alternatively be a PDA, smart phone or any other network-enabled device. However, regardless of the form of node 300 it will typically comprise a processor 312, a memory 314, a data store 316, a communications bus 318 and an interface 320. The communications bus 318 provide a means for transferring data between the processor 312, memory 314, data store 316 and interface 320. Memory 314 may be volatile memory such as RAM or non-volatile memory such as EPROM or flash memory. The data store 316 is typically a magnetic, solid state (e.g. flash memory) or optical storage medium arranged for storing data such as a database, a table, or a plurality of files. The processor 312 will typically be a software controlled microprocessor (for example an Intel Pentium® processor) or an application specific integrated circuit (ASIC) or the like. The interface 320 provides means for communicating with the management server and other nodes in the WAN using a standard protocol such as TCP/IP over Ethernet. The processor 312 is configured to interact with the memory 314, data store 316 and interface 320 to perform a number of functions according to a software program. However, it will be appreciated that functionality may equally be realised using firmware, or an appropriate combination of both software and firmware.

The software management agent 330 is typically loaded from the data store 316 and runs in memory 314. The node 300 also stores a package repository 370 in the data store 316, which is a store of all complete and partial packages held by the node 300. In the illustrated embodiment, the management agent 330 comprises three modules: a core module 340, a local module 350 and a remote module 360. The core module 340 provides the core functionality necessary for locating and retrieving packages on the WAN, including a role management function 342, inventory management function 344, package management function 346 and a communication function 348.

The role management function 342 controls the role of the node on which the management agent is running (i.e. primary or normal) and responds to requests for role upgrades and role downgrades.

The inventory management function 344 provides an up to date inventory of the nodes hardware inventory, IP address and/or hostname. In some embodiments, the inventory management function 344 is configured to periodically determine if any changes have been made to the node's hardware and if necessary update the inventory. In response to a change in the node's inventory the inventory management function 344 is configured to resend the updated inventory to the management server 150 using the communication function 348.

The package management function 346 manages the package repository 370 and, in response to incoming package requests, queries the package repository 370 to determine if the requested package is present. As shown in FIG. 3, each package 380 in the package repository 370 comprises a package ID 382, one or more files 386, 388, 390, and a manifest 384 listing the files present and their respective hash values.

The communication function 348 manages all communications with the management server 150 and other nodes in the WAN.

Each node running the management agent sends a periodic ‘heartbeat’ message to the management server 150 in order that the management server can determine which nodes are operational. Nodes which are not operating as primary nodes send heartbeat messages at a relatively low frequency (e.g. once every 10 minutes) whereas nodes which are operating as primary nodes send heartbeat messages at a relatively higher frequency (e.g. once every 10 seconds).

In response to receiving a heartbeat message, the management server 150 may respond to the originating node by issuing a role upgrade or role downgrade request. For example, upon receiving a heartbeat message from a normal node, the management server 150 may respond by issuing an upgrade request such that the node becomes the primary node for the respective subnet. Accordingly, the originating node receives the upgrade request, and the role management function 342 switches to a primary role and the node proceeds to issue heartbeat messages and a higher frequency. In this manner, the periodic heartbeat messages provide information to the management server regarding which nodes are operational and which of the subnets have operational primary nodes.

As discussed above, when a node is instructed to locate and retrieve a target package it first attempts to locate nodes holding the package that are on the local subnet. The functionality necessary to achieve this is provided by local module 350. This module provides a subnet locate function 352, a package retrieve function 354 and a package validate function 356. These functions provide the necessary functionality to perform a local subnet election and retrieval using existing functionality such as the Nomad Branch® functionality described above.

If the node fails to find the target package on the local subnet the node attempts to locate the target package on different subnets. The functionality necessary to achieve this is provided by the remote module 360. The remote module 360 comprises a candidate request function 362, a metric calculation function 364, a ranking function 366 and a voting function 368.

The ranking function 366 calculates a score associated with each candidate node based on the one or more metrics determined by the metric calculation function. For example, the score Sᵢ for a candidate node i may be calculated according to the following formula:

$${S}_{i} = {Ω}_{i} \times {\sum }_{j = 1}^{N} ( {W}^{j} \times {M}_{i}^{j} )$$

where: Sᵢ is the score for candidate node i;
Ωᵢ is a delta function for candidate node i;
W^{j} is a weighting factor for metric j;
Mᵢ^{j} is the metric j for candidate node i.

The delta function Ωᵢ represents whether candidate node i is contactable (Ωᵢ=1) or not contactable (Ωᵢ=0). The weighting factor W^{j} is used to weight those metrics of relatively higher importance (e.g. bandwidth). Once a score Sᵢ has been calculated for each candidate node i, the requesting node can proceed to rank the candidate nodes and send a package request to each in turn.

The voting function 368 provides a means for a requesting node to send a vote to the management server 150 upon successful retrieval of the target package. The management server 150 stores received votes and references them when determining future candidate nodes.

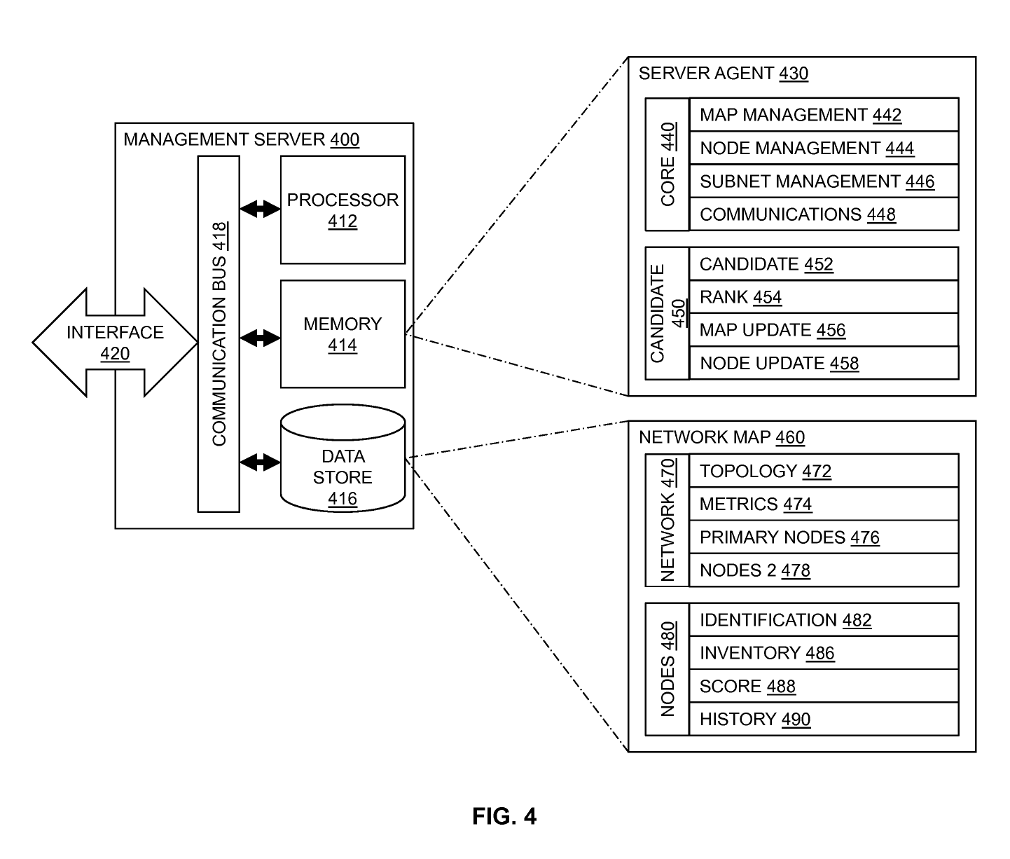

An embodiment of the management server running the server agent is now described with reference to FIG. 4. The server agent provides the necessary functionality to monitor subnets in the WAN, respond to candidate requests and maintain a network map. In an embodiment of the invention, functionality provided by the management application may be grouped according to (i) core functionality, and (ii) candidate functionality. This functionality is provided by respective core and candidate modules, which are described in more detail below.

FIG. 4 shows a management server 400 in accordance with an embodiment of the invention. In the present embodiment, the management server 400 comprise a processor 412, a memory 414, a data store 416, a communications bus 418 and an interface 420. The communications bus 418 provide a means for transferring data between the processor 412, memory 414, data store 416 and interface 420. Memory 414 may be volatile memory such as RAM or non-volatile memory such as EPROM or flash memory. The data store 416 is typically a magnetic, solid state (e.g. flash memory) or optical storage medium arranged for storing data such as a database, a table, or a plurality of files. The processor 412 will typically be a software controlled microprocessor (for example an Intel Pentium® processor) or an application specific integrated circuit (ASIC) or the like. The interface 420 provides means for communicating with the management server and other nodes in the WAN using a standard protocol such as TCP/IP over Ethernet. The processor 412 is configured to interact with the memory 414, data store 416 and interface 420 to perform a number of functions according to a software program. However, it will be appreciated that functionality may equally be realised using firmware, or an appropriate combination of both software and firmware.

The server agent 430 is typically loaded from the data store 416 and runs in memory 414. The management server 400 also stores a network map 460 in the data store 416. The server agent 430 comprises two modules: a core module 440, and a candidate module 450. The core module 440 provides the core functionality necessary for monitoring subnets and nodes on the WAN, including a network map management function 442, node management function 444, subnet management function 446 and a communication function 448.

The communication function 448 manages all communications between the management server 150 and other nodes in the WAN.

The node management function 444 monitors each node, which sends a heartbeat and ensures that the network map 460 is updated in response to changes in node inventory etc.

The subnet management function 446 maintains a list (typically stored in network map 460) of all primary nodes for subnets in the WAN 100 and where possible ensures that a primary node is assigned to each known subnet in the WAN 100. Where more than one primary node exists for a particular subnet, the subnet management function 446 may optionally select a single primary node for the particular subnet, and may issue a role downgrade to the other nodes.

When the node management function 444 receives or acquires inventory information for a node associated with a previously unknown subnet, or a subnet for which there is currently no assigned primary node, the subnet management function 446 considers this node to be the assigned primary node for that subnet and issues a role upgrade request to the node in question.

Similarly, if the subnet management function 446 determines that, for a particular subnet, the primary agent heartbeat has not been received for a specific length of time (e.g. ten minutes) then a role upgrade request will be issued to a different node on the subnet such that it becomes the primary node.

If the subnet management function 446 does not receive a heartbeat from any nodes on a particular remote subnet for more than an predefined period (e.g. twenty four hours), the subnet is considered obsolete and excluded until such time as a new inventory is received and a new primary node is assigned.

The candidate function 452 is configured to determine a list of candidate nodes (a sub-set of the assigned primary nodes) in response to a request from a node, as discussed above. The determination process employed by the candidate function 452 may take account of the following factors for each assigned primary node (the necessary information may be obtained from the network map 460 as appropriate):
Has a heartbeat been received from the primary node in question (e.g. within the last one minute)?
Has connectivity between the subnet associated with the requesting node and the subnet associated with the primary node in question been denied in a preceding period (e.g. ten days)?
Has connectivity between the subnet associated with the requesting node and the subnet associated with the primary node in question been prohibited by a central exclusion list?

Where one or more metrics are known for the subnet associated with the primary in question and the subnet associated with the requesting node, the determination process may further account for the following factors:
Has the subnet associated with the primary node been voted as a good neighbour in the past?
Was the last known hop count between the subnet associated with the primary node and the subnet associated with the requesting node below a configurable limit?
Was the last known latency for the subnet associated with the primary node and the subnet associated with the requesting node below a configurable limit?

Where no data exists for the subnets in question, further factors may be accounted for in the determination process, such as:
Do the subnet associated with the primary node and the subnet associated with the requesting node share the same default network printer?
Do the subnet associated with the primary node and the subnet associated with the requesting node share a domain controller?
Do the subnet associated with the primary node and the subnet associated with the requesting node share the same first IP octet?
Is the subnet associated with the primary node assigned to the same remote systems management server as the subnet associated with the requesting node?
Is the subnet associated with the primary node assigned to the same Active Directory Site as the subnet associated with the requesting node?

Data stored in the network map 460 in respect of primary nodes (e.g. metrics, scores, votes etc.) can be weighted such that recently acquired data is attributed greater importance when determining the list of candidate nodes. This can been achieved by use of a suitable time based weighting factor to in effect ‘age out’ old data which may be of limited relevance.

In some embodiments, once the list of candidate nodes has been determined by the candidate function 452, the rank function 454 is configured to order the candidate nodes according to a ranking prior to returning the list to the requesting node. For example, the candidates nodes may be ranked according to the number of times that the each candidate node has been voted as useful in the past (i.e. on the basis of score 488). In an alternative embodiment, it is preferable to return the list of candidate nodes in a randomised order to ensure load balancing between primary nodes (i.e. to avoid the primary node with the highest score being returned first each time).

Where insufficient information exists to determine candidate nodes based on votes or metrics, the candidate nodes may be selected randomly. For example, such circumstances may arise where the management server has been installed for the first time and no historic data is available.

It will be appreciated that the methods disclosed herein may be implemented as software stored on a computer program product. The product may comprise a computer readable medium for example a magnetic or optical disk, electronic memory, for example flash memory, RAM, ROM or hard disk amongst other media. The software will comprise computer readable instructions, which are executable by a computerized device to cause the computerized device to perform the methods described above. For example, the computer program product may comprise instructions, which, when executed, cause a computerized device to perform the part or all of the method illustrated in FIG. 2.

The above embodiments are to be understood as illustrative examples of the invention. Further embodiments of the invention are envisaged. For example, the management agent may provide for nodes to act in a secondary role (hereinafter termed ‘secondary nodes’). The secondary nodes send a heartbeat message to the management server at a rate between those of the primary nodes and normal nodes. When the management server determines that no primary node exists for a particular subnet, it can issue a role upgrade request to a secondary node in preference to a normal node.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A computer-implemented method of locating and retrieving a package over a network, the network comprising a management server storing data relating to a plurality of primary nodes, each primary node being associated with a subnet of the network and responsible for locating the package on its associated network, the method comprising:
sending, from a requesting node on a first subnet, a package request to the management server, and, upon receipt of the package request, determining, at the management server, a subset of the primary nodes;
receiving, at the requesting node, a response from the management server comprising address data associated with the determined subset of primary nodes;
determining, at the requesting node, one or more metrics associated with each of the subset of primary nodes so as to determine a useful primary node on a second subnet;
sending, from the requesting node on the first subnet, a request for the package to the determined useful primary node on the second subnet, and, upon receipt of the request, determining, at the useful primary node, one or more neighbour nodes on the second subnet holding part or all of the requested package;
receiving, at the requesting node on the first subnet, a response from the determined useful primary node comprising address data associated with the determined one or more neighbour nodes holding part or all of the requested package; and
selecting, at the requesting node, one or more target nodes from the one or more neighbour nodes, and retrieving, to the requesting node, part or all of the package from the selected one or more target nodes.

2. The computer-implemented method according to claim 1, wherein each of the subset of primary nodes is a primary node for which a route to the first subnet is determined or known to exist.

3. The computer-implemented method according to claim 1, further comprising sending the determined one or more metrics to the management server.

4. The computer-implemented method according to claim 3, wherein the subset of primary nodes is determined by the management server on the basis of the received one or more metrics.

5. The computer-implemented method according to claim 1, further comprising sending a vote to the management server upon successful retrieval of the part or whole of the package, the vote being associated with the useful primary node associated with the subnet from which the part or whole of the package was retrieved.

6. The computer-implemented method according to claim 5, wherein the subset of primary nodes is determined by the management server on the basis of the received votes.

7. The computer-implemented method according to claim 1, wherein the subset of primary nodes is determined as the primary nodes sharing one or more of the following with the requesting node: a default network printer, a domain controller, a remote systems management server, an Active Directory site, the first IP octet of the associated subnets.

8. The computer-implemented method according to claim 1, wherein the metrics include one or both of a bandwidth between the first subnet and the second subnet, and a hop-count between the first subnet and the second subnet.

9. The computer-implemented method according to claim 1, wherein, upon receipt of the package request, the management server determines the subset of primary nodes on the basis of a network map.

10. A management server for use in a computer-implemented method of locating and retrieving a package over a network, the network having a plurality of primary nodes, each primary node being associated with a subnet of the network and responsible for locating the package on an associated network, wherein:
the management server stores data relating to the plurality of primary nodes;
the management server determines a subset of the primary nodes upon receipt of a package request from a requesting node on a first subnet; and
the management server sends a response, to the requesting node, comprising address data associated with the determined subset of primary nodes.

11. A node for use in a network having a management server and a plurality of primary nodes, each primary node being associated with a subnet of the network and responsible for locating the package on its associated network, the management server storing data relating to the plurality of primary nodes, wherein:
the node is operable to send a package request to the management server,
the node determines one or more metrics associated with each of the subset of primary nodes so as to determine a useful primary node on a second subnet upon receipt of data, from the management server, relating to a subset of the primary nodes;
the node is operable to send a request for the package to the determined useful primary node on the second subnet, and, upon receipt of the request, the useful primary node determines one or more neighbour nodes on the respective subnet holding part or all of the requested package;
the node is operable to receive a response from the determined useful primary node, the response comprising address data associated with the determined one or more neighbour nodes holding part or all of the requested package; and
the node is operable to select one or more target nodes from the one or more neighbour nodes and retrieve part or all of the package from the selected one or more target nodes.

12. A computer program product comprising a non-transitory computer-readable storage medium having computer readable instructions stored thereon, the computer readable instructions being executable by a computerized device to cause the computerized device to perform a method for locating and retrieving a package over a network comprising a management server storing data relating to a plurality of primary nodes, each primary node being associated with a subnet of the network and responsible for locating the package on its associated network, the method comprising:
sending, from a requesting node on a first subnet, a package request to the management server, and, upon receipt of the package request, determining, at the management server, a subset of the primary nodes;
receiving, at the requesting node, a response from the management server comprising address data associated with the determined subset of primary nodes;
determining, at the requesting node, one or more metrics associated with each of the subset of primary nodes so as to determine a useful primary node on a second subnet;
sending, from the requesting node on the first subnet, a request for the package to the determined useful primary node on the second subnet, and, upon receipt of the request, determining, at the useful primary node, one or more neighbour nodes on the second subnet holding part or all of the requested package;
receiving, at the requesting node on the first subnet, a response from the determined useful primary node comprising address data associated with the determined one or more neighbour nodes holding part or all of the requested package; and
selecting, at the requesting node, one or more target nodes from the one or more neighbour nodes, and retrieving, to the requesting node, part or all of the package from the selected one or more target nodes.

13. The computer program product according to claim 12, wherein each of the subset of primary nodes is a primary node for which a route to the first subnet is determined or known to exist.

14. The computer program product according to claim 12, wherein the method further comprises sending the determined one or more metrics to the management server.

15. The computer program product according to claim 14, wherein the subset of primary nodes is determined by the management server on the basis of the received one or more metrics.

16. The computer program product according to claim 12, wherein the method further comprises sending a vote to the management server upon successful retrieval of the part or whole of the package, the vote being associated with the useful primary node associated with the subnet from which the part or whole of the package was retrieved.

17. The computer program product according to claim 12, wherein the subset of primary nodes is determined by the management server on the basis of the received votes.

18. The computer program product according to claim 12, wherein the subset of primary nodes is determined as the primary nodes sharing one or more of the following with the requesting node: a default network printer, a domain controller, a remote systems management server, an Active Directory site, the first IP octet of the associated subnets.

19. The computer program product according to claim 12, wherein the metrics include one or both of a bandwidth between the first subnet and the second subnet, and a hop-count between the first subnet and the second subnet.

20. The computer program product according to claim 12, wherein, upon receipt of the package request, the management server determines the subset of primary nodes on the basis of a network map.

21. A computer program product comprising a non-transitory computer-readable storage medium having computer readable instructions stored thereon, the computer readable instructions being executable by a computerized device to cause the computerized device to act as the management server of claim 10.

22. A computer program product comprising a non-transitory computer-readable storage medium having computer readable instructions stored thereon, the computer readable instructions being executable by a computerized device to cause the computerized device to act as the node of claim 11.
